(19) United States
(12) Patent Application Publication
(10) Pub. No.: US 2006/0288844 A1
(43) Pub. Date: Dec. 28, 2006

(54) DATA PROCESSING METHOD CAPABLE OF RECONSTRUCTING LOST OR ERRONEOUS DATA

(76) Inventors: Yi-Chao Chang, Hsin-Chu Hsien (TW); Hui-Ming Wang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/162,978

(22) Filed: Sep. 29, 2005

(30) Foreign Application Priority Data
Jun. 28, 2005 (TW) 094121642

(51) Int. Cl. G10H 7/08

(52) U.S. Cl. 84/607

(57) ABSTRACT

A data processing method encodes data points obtained by sampling data having continuous physical quantity, stores the nth data of the mth data set into a first data frame, stores the (n+1)th data of the mth data set into a second data frame, stores an nth data point of an (m+1)th data set into the first data frame, and stores an (n+1)th data point of the (m+1)th data set into the second data frame. When an interference causes data loss or data error, reconstructed data points approximating the lost data points are generated from other correct data points at a receiver by using a predetermined algorithm.

### BACKGROUND OF THE INVENTION

1. Field of the Invention

The present invention relates to a data processing method, and more particularly, to a data processing method capable of reconstructing lost or erroneous data.

2. Description of the Prior Art

When handling data having continuous physical quantity, such as voices, currents, waveforms or temperatures, a plurality of data points can be obtained at a predetermined sampling rate. Then the sampled data points are stored or outputted for further data processing.

Please refer to FIG. 1. In FIG. 1, a waveform 10 represents an audio signal, the x-axis represents time, and the y-axis represents the strength of the audio signal at a given time. If the audio signal is sampled k times per second, a plurality of data points A1-An, each of which are separated by an interval of (1/k) second, can be obtained from the waveform 10. A higher sampling rate k results in a higher value of n and more data points obtained from the waveform 10. Therefore, the data points A1-An will better approximate the waveform 10 using a higher sampling rate k. Suppose after sampling, 28 data points A1-A28 can be obtained from the waveform 10, the data points A1-A28 are usually stored in form of data frames for further data processing.

Please refer to FIG. 2 illustrating a prior art data processing method for the data points obtained by sampling the waveform 10. According to the sampling time, the data points A1-A28 are stored sequentially into data frames G1-G4, respectively. In other words, the data frame G1 includes the data points A1-A7, the data frame G2 includes the data points A8-A14, the data frame G3 includes the data points A15-A21, and the data frame G4 includes the data points A22-A28. Also, based on the data points stored in each data frame, corresponding error detect codes (EDCs) and error correction codes (ECC) are generated and stored into respective data frames. Finally the data frames G1-G4 are outputted in a sequence of G1-G2-G3-G4.

In an ideal communication system, a transmitter sends data frames encoded with data which has been sampled, and data received by a receiver should be identical to that sent from the transmitter. However, due to communication system hardware limitations, transmitting media and other interferences, data discrepancy or data loss are inevitable in real applications. Generally, an interference causes continuous mistakes, which means data contained in a certain block will be affected at the same time. In the prior art data processing method, the receiver determines if data losses or data errors occur based on the received EDCs, and repairs missing or erroneous data points based on the received ECCs. However, since an interference usually causes continuous mistakes, data and its corresponding EDCs and ECCs stored in a same data frame will likely be missing together, which makes data reconstruction from the EDCs and ECCS infeasible.

Please refer to FIG. 3 for data 30 representing the waveform 10 received by the receiver after the waveform 10 has been handled with the prior art data processing method. If an interference occurs during data transmission and data stored in an interference region S including data frames G3 and G4 are lost, the signal received by the receiver is shown in FIG. 3. When the interference influences the data frames G3 and G4, the data points A15-A28, together with their corresponding EDCs and ECCs, will be lost. Under this circumstance, data reconstruction is impossible at the receiver, and the data 30 received by the receiver and the actual waveform 10 have a large data discrepancy.

In the prior art data processing method, EDCs and ECCs are used for reconstructing lost or erroneous data. Extra space is required for storing the EDCs and ECCs. When an interference causing continuous mistakes occurs, data reconstruction can fail due to loss of data and its corresponding ECCs and EDCs stored in a same data frame at the same time.

### SUMMARY OF THE INVENTION

It is therefore a primary objective of the claimed invention to provide a data processing method capable of reconstructing lost or erroneous data in order to solve the problems of the prior art.

The claimed invention discloses a data processing method capable of reconstructing lost or erroneous data comprising storing an nth data point of an mth data set comprising a plurality of continuous data points into a first data frame and storing an (n+1)th data point of the mth data set into a second data frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a waveform representing an audio signal.

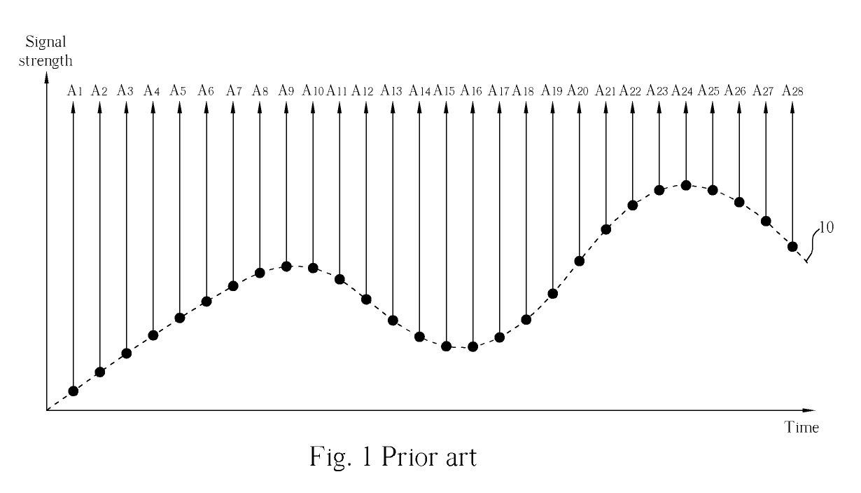

FIG. 2 is a diagram illustrating a prior art data processing method.

FIG. 3 shows data received by a receiver.

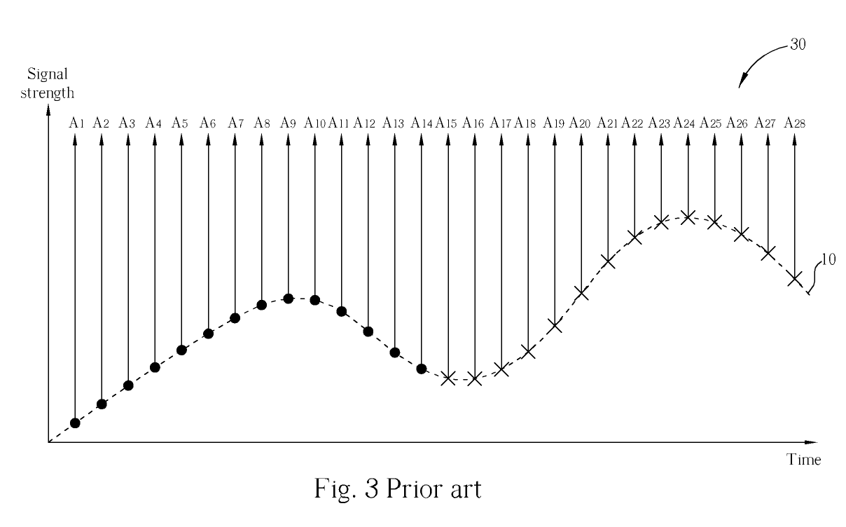

FIG. 4 is a diagram illustrating a data processing method according to a first embodiment of the present invention.

FIG. 5 shows data received by a receiver in the first embodiment of the present invention.

FIG. 6 is a diagram illustrating a data processing method according to a second embodiment of the present invention.

FIG. 7 shows data received by a receiver in the second embodiment of the present invention.

### DETAILED DESCRIPTION

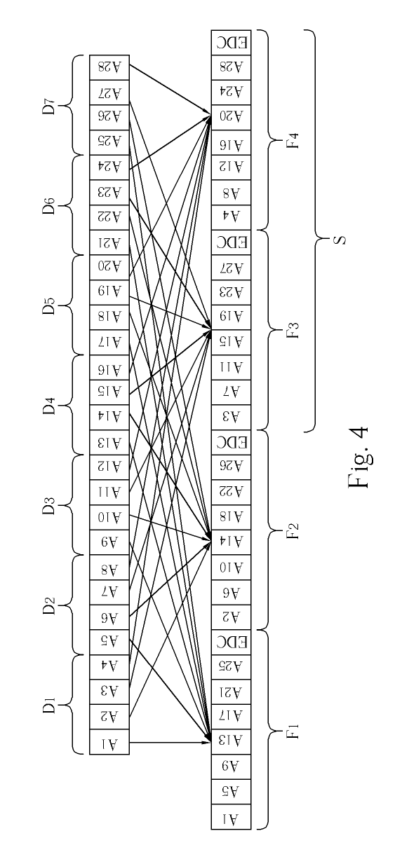

Please refer to FIG. 4 for a data processing method for the data points obtained by sampling the waveform 10 according to a first embodiment of the present invention. If 28 data points A1-A28 are acquired after sampling the waveform 10, the data points A1-A28 are handled as 7 data sets D1-D7 in the first embodiment of the present invention. Based on the sampling sequence, the data sets D1-D7 include data points A1-A4, A5-A8, A9-A12, A12, A13-A16, A17-A20, A21-A24, and A25-A28, respectively. In the first embodiment of the present invention, the data points A1-A28 are encoded so that they can be stored into data frames F1-F4 in a predetermined sequence. As shown in FIG. 4, the data points A1, A5, A9, A13, A17, A21 and A25 are stored into the data frame F1, the data points A2, A6, A10, A14, A18, A22, A26 are stored into the data frame F2, the data points A3, A7, A11, A15, A19, A23, A27 are stored into the data frame F3, and the data points A4, A8, A12, A16, A20, A24, A28 are stored into the data frame F4. In other words, the first data points of the data sets D1-D7 are stored into the data frame F1 sequentially, the second data points of the data sets D1-D7 are stored into the data frame F2 sequentially, the third data points of the data sets D1-D7 are stored into the data frame F2 sequentially, and the fourth data points of the data sets D1-D7 are stored into the data frame F4 sequentially. Finally, the data frames F1-F4 are outputted in a sequence F1-F2-F3-F4.

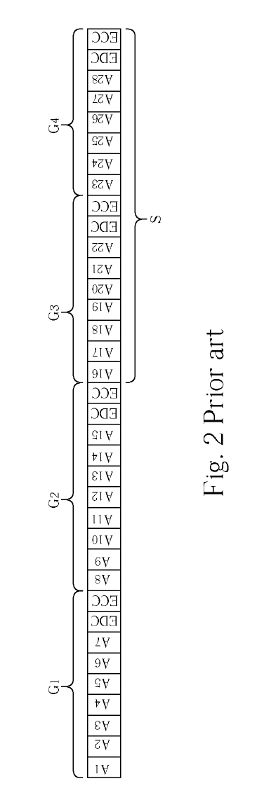

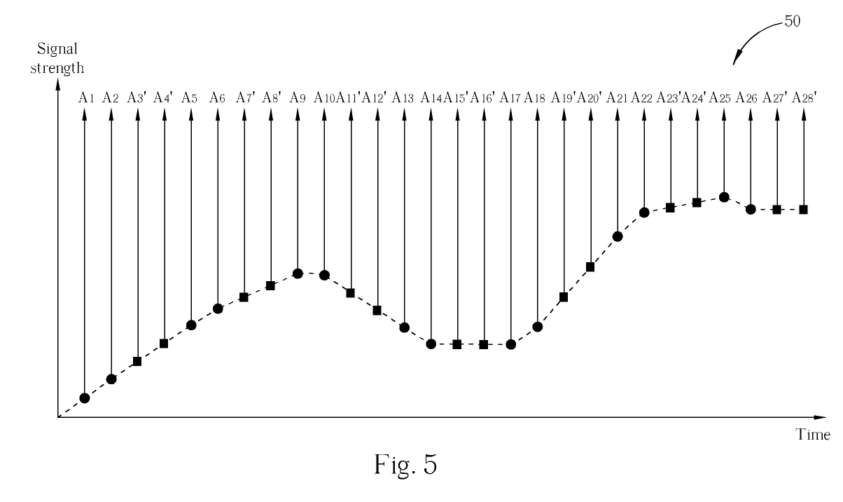

Please refer to FIG. 5 for data 50 representing the waveform 10 received by the receiver after the waveform 10 has been handled with the method of the first embodiment of the present invention. If the same interference as encountered in FIG. 2 occurs during data transmission and data stored in an interference region S including data frames F3 and F4 is lost, the signal received by the receiver is shown in FIG. 5. Since the waveform 10 represents an audio signal having continuous physical quantity, the continuous data points acquired by sampling the waveform 10 are characterized in that adjacent data points have slight data variance. Based on this characteristic, the present invention reconstructs the lost data points A3, A4, A7, A8, A11, A12, A15, A16, A19, A20, A23, A24, A27 and A28 stored in the data frames F3 and F4. By using algorithms such as interpolation, the receiver generates reconstructed data points A3′ and A4′ approximating the lost data points A3 and A4 from the correct data points A2 and A5, data points A7′ and A8′ approximating the lost data points A7 and A8 from the correct data points A6 and A9, data points A11′ and A12′ approximating the lost data points A11 and A12 from the correct data points A10 and A13, data points A15′ and A16′ approximating the lost data points A15 and A16 from the correct data points A14 and A17, data points A19′ and A20′ approximating the lost data points A19 and A20 from the correct data points A18 and A21, data points A23′ and A24′ approximating the lost data points A23 and A24 from the correct data points A22 and A25, and data points A27′ and A28′ approximating the lost data points A27 and A28 from the correct data point A26. Hence, after processing data with the method of the first embodiment of the present invention, even if an interference during data transmission causes large amounts of data loss or error, the receiver can generate reconstructed data points for the lost data points based on other correct data points. As shown in FIG. 5, the discrepancy between the data 50 after data reconstruction and the original waveform 10 is negligible.

In the present invention, the data points acquired by sampling data having continuous physical quantity are encoded. Using the characteristic of slight data variance between adjacent data points, the reconstructed data points approximating the lost data points can be generated from other correct data points. The present invention enables data reconstruction even if large amount of data stored in the same region is lost or distorted during data transmission. Also, since the lost or erroneous data is reconstructed at the receiver using algorithms such as interpolation, only EDCs used for detecting errors are required. The present invention does not require ECCs and can thus increase data transmission capacity.

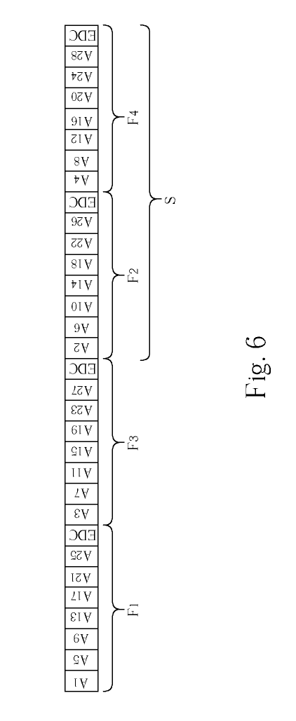

Please refer to FIG. 6 for a data processing method for the data points obtained by sampling the waveform 10 according to a second embodiment of the present invention. In the second embodiment, data points A1-A28 representing the waveform 10 are encoded and stored into the data sets D1-D7 in the same way as in the first embodiment. That is, the data frame F1 includes the data points A1, A5, A9, A13, A17, A21, A25 and their corresponding EDC, the data frame F2 includes the data points A2, A6, A10, A14, A18, A22, A26 and their corresponding EDC, the data frame F3 includes the data points A3, A7, A11, A15, A19, A23, A27 and their corresponding EDC, and the data frame F4 includes the data points A4, A8, A12, A16, A20, A24, A28 and their corresponding EDC. The second embodiment differs from the first embodiment in that the data frames F1-F4 are outputted in a sequence of F1-F2-F3-F4 in the first embodiment, while the data frames F1-F4 are outputted in a sequence of F1-F3-F2-F4 in the second embodiment.

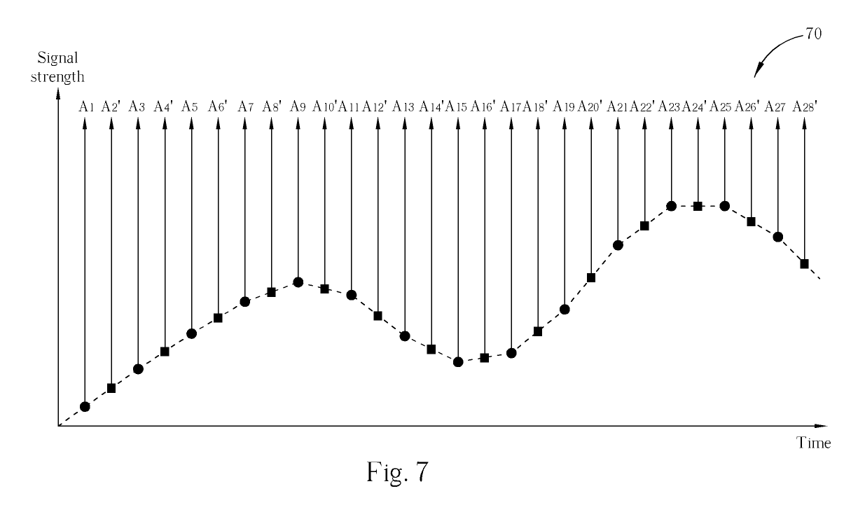

Please refer to FIG. 7 for data 70 representing the waveform 10 received by the receiver after the waveform 10 has been handled with the method of the second embodiment of the present invention. If the same interference as encountered in FIG. 2 occurs during data transmission and data stored in an interference region S including data frames F2 and F4 are lost, the signal received by the receiver is shown in FIG. 7. Also based on the characteristic of slight data variance between adjacent data points sampled from data having continuous physical quantity, the present invention reconstructs the lost data points A2, A4, A6, A8, A10, A12, A14, A16, A18, A20, A22, A24, A26, A28 stored in the data frames F2 and F4. By using algorithms such as interpolation, the receiver generates reconstructed data points A2′, A4′, A6′, A8′, A10′, A12′, A14′, A16′, A18′ and A20′, A22′, A24′, A26′, A28′ approximating the lost data points A2, A4, A6, A8, A10, A12, A14, A16, A18, A20, A22, A24, A26, A28 from the correct data points A1, A3, A5, A7, A9, A11, A13, A15, A17, A19, A21, A23, A25 and A27. Hence, after processing data with the method of the second embodiment of the present invention, even if an interference during data transmission causes large amount of data loss or error, the receiver can generate reconstructed data points for the lost data points based on other correct data points. As shown in FIG. 7, the second embodiment provides the data 70 which better approximates the original waveform 10 than the data 50 provided by the first embodiment.

In the prior art data processing method, EDCs and ECCs are required for reconstructing lost data. Extra space for storing the EDCs and ECCs reduces data transmission capacity. When an interference causing continuous mistakes occurs, data reconstruction can fail due to loss of data and its corresponding ECCs and EDCs stored in a same data frame at the same time. Compared to the prior art, the present invention encodes the data points acquired by sampling data having continuous physical quantity. Using the characteristic of slight data variance between adjacent data points, the reconstructed data points approximating the lost data points can be generated from other correct data points. The present invention enables data reconstruction even if large amount of data stored in the same region is lost or distorted during data transmission. Also, since lost data is reconstructed at the receiver using algorithms such as interpolation, only EDCs used for detecting errors are required. The present invention does not require ECCs and can therefore increase data transmission capacity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing method capable of reconstructing lost or erroneous data comprising:
storing an nth data point of an mth data set comprising a plurality of continuous data points into a first data frame; and
storing an (n+1)th data point of the mth data set into a second data frame.

2. The data processing method of claim 1 further comprising:
obtaining the plurality of continuous data points by sampling a data stream with a predetermined frequency.

3. The data processing method of claim 1 further comprising:
generating a first error detect code (EDC) corresponding to the nth data point of the mth data set and a second error detect code corresponding to the (n+1)th data point of the mth data set.

4. The data processing method of claim 3 further comprising:
storing the first and second error detect codes into the first and second data frames, respectively.

5. The data processing method of claim 1 further comprising: outputting the first and second data frames sequentially.

6. The data processing method of claim 1 further comprising:
outputting the second and first data frames sequentially.

7. The data processing method of claim 1 further comprising:
storing an nth data point of an (m+1)th data set comprising a plurality of continuous data points into the first data frame; and
storing an (n+1)th data point of the (m+1)th data set into the second data frame.

8. The data processing method of claim 7 further comprising:
generating a third error detect code corresponding to the nth data point of the (m+1)th data set and a fourth error detect code corresponding to the (n+1)th data point of the (m+1)th data set.

9. The data processing method of claim 8 further comprising:
storing the third and fourth error detect codes into the first and second data frames, respectively.

10. The data processing method of claim 7 wherein the mth and (m+1)th data sets comprise a same amount of data points.
